(19) United States
(12) Patent Application Publication
(10) Pub. No.: US 2006/0175098 A1
(43) Pub. Date: Aug. 10, 2006

(54) ACTIVATABLE FORWARD WHEEL STEERING MECHANISM FOR A ZERO TURN LAWNMOWER

(76) Inventor: BAILEY SUTHERLAND, MARBLE FALLS, TX (US)

Correspondence Address: PATENT-TRADEMARK-COPYRIGHT. US, 2200 S. FORT APACHE ROAD #1213, LAS VEGAS, NV, 89117, US

(21) Appl. No.: 11/307,402

(22) Filed: Feb. 6, 2006

Related U.S. Application Data
(60) Provisional application No. 60/650,586, filed on Feb. 7, 2005.

(51) Int. Cl. B62D 11/24

(52) U.S. Cl. 180/6.24

(57) ABSTRACT

A zero turn lawnmower with an optional front wheel steering mechanism is disclosed that enables an operator to independently control both rear and front wheels. The disclosed front wheel steering mechanism includes mechanical, electro-mechanical, and electronic embodiments implemented to control the direction of orientation of one or more front wheels.

This application claims priority to U.S. Provisional Application No. 60/650,586, filed on Feb. 07, 2005, the entire contents of which are also incorporated herein by reference.

### FIELD OF THE INVENTION

The present invention relates generally to zero-turn lawnmowers, and more particularly to a front wheel steering mechanism for assisting operators to control the zero-turn lawnmower front wheels.

### BACKGROUND OF THE INVENTION

Zero-turn lawnmowers are conventionally operated with a rear wheel drive and steering mechanism that allows an operator to engage and separately change the speed of each rear wheel independently of the other wheel. In these conventional zero-turn lawnmowers, the forward wheels are free-turning and simply follow the force from the rear wheels through the frame. This style of steering mechanism provides for quick maneuverability and enables movement of the zero-turn lawnmower through terrain and in spaces where front wheel steer tractors have difficulty.

Difficulties may be encountered by operators when operating conventional zero-turn lawnmowers in various situations. In one situation, an operator of a zero-turn lawnmower travelling across a slope may lose upper rear wheel traction, causing the lawnmower to turn downhill and resulting in a loss of control by the operator. In another situation, an operator attempting to make a sharp turn may lose the traction of the rear drive wheels, causing a spinout and resulting in damage to the underlying turf.

As a result, there is a need for a mechanism that provides an operator with additional control in certain situations, such as when negotiating hilly terrain or sharp turns.

### SUMMARY OF THE INVENTION

The present invention provides an optional front wheel control mechanism to provide an operator with control of both rear and front wheels comprising an engageable hand or foot mechanism to control the direction of orientation of one or more front wheels on a zero-turn lawnmower with operator controlled rear wheel drive.

### BRIEF DESCRIPTION OF THE DRAWINGS

The accompanying drawings incorporated in and forming a part of the specification, illustrates several aspects of the present invention, and together with the description serves to explain the principles of the invention. In the drawing:

FIG. 1 is a view of a first embodiment of a zero-turn lawnmower with a mechanical forward wheel steering mechanism of the present invention.

FIG. 1A is a view of a first embodiment of the right forward wheel steering mechanism of the present invention.

FIG. 1B is a view of a first embodiment of the left forward wheel steering mechanism of the present invention.

FIG. 2 is an overhead view of a second embodiment of a zero-turn lawnmower with an electrical forward wheel steering mechanism of the present invention.

FIG. 3 is a close-up view of the electrical controlled steering hardware of the second embodiment of the forward wheel steering mechanism of the present invention.

FIG. 4 is an example electrical circuit diagram of the second embodiment of the forward wheel steering mechanism of the present invention.

### DETAILED DESCRIPTION OF THE INVENTION

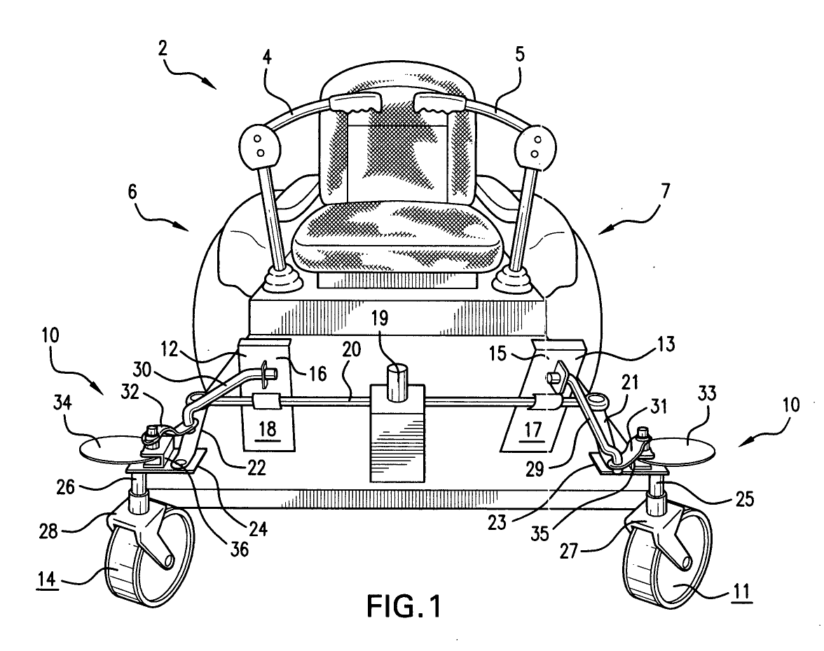

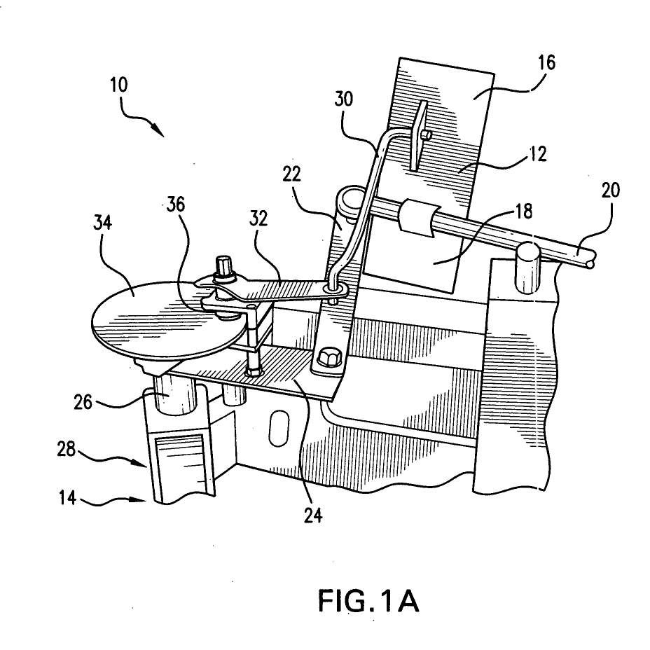

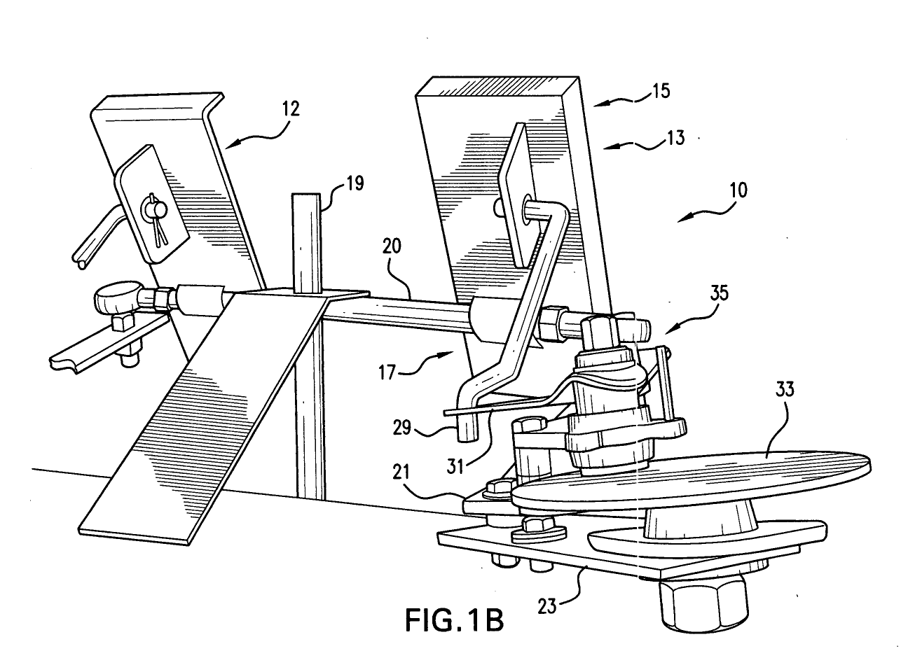

Referring to FIG. 1, a first embodiment of forward wheel steering mechanism 10 of the present invention is shown that is mechanically implemented and usable by an operator of zero-turn lawnmower 2 to control the direction of orientation of the front wheels. Zero-turn lawnmower 2 includes right and left steering levers 4, 5 for respectively controlling the direction and rotational speed of right and left rear wheels 6, 7 and forward wheel steering mechanism 10 for controlling the direction of right and left forward wheels 14, 11. Forward wheel steering mechanism 10 includes foot pedal 12 which is engageable with forward wheel 14 when an operator applies pressure with the operator's foot. Once engaged with forward wheel 14, foot pedal 12 may be used to guide the direction of forward wheel 14 in one direction depending upon pressure applied to heel portion 18 of foot pedal 12 or in the opposite direction depending upon pressure applied to heel portion 17 of foot pedal 13. Pressure to toe portion 15, 16 respectively locks direction of wheel 11, 14. In one embodiment, forward wheel 14 turns to the right when pressure is applied to heel portion 18. Foot pedals 12, 13 are pivotally attached to rocker arm 20. Rocker arm 20 is pivotally attached to the main body of zero-turn lawnmower through pin 19 and pivotally attached to rods 21, 22 which are respectively swivelly connected to horizontal arms 23, 24. Horizontal arms 23, 24 are fixed to vertical shafts 25, 26. Vertical shafts 25, 26 are fixed to wheel housings 27, 28 so that the wheel is maintained in a particular orientation with respect to vertical shafts 25, 26. Rods 29, 30 swivelly connects toe portions 15, 16 of foot pedals 13, 12 to horizontal arms 31, 32. Horizontal arms 31, 32 swivelly connect to brake pad mechanisms 35, 36 overlaying horizontal saucers 33, 34 which in turn are fixed to vertical shafts 25, 26. When toe portions 15, 16 are respectively depressed, brake pad mechanisms 35, 36 engage respectively with horizontal saucers 33, 34 and lock the respective wheel 11, 14 in a selected directional orientation.

FIG. 1A shows a close-up view of right wheel steering assembly 10, FIG. 1B shows left wheel steering assembly 10. While assemblies 10 are tied by rocker arm 20 and pivot pin 19, forward wheel steering mechanism 10 enables some independent steering operation of the left and right wheels by separate use of brake assemblies 35, 36 and separately sliding foot pedals 12, 13 along rocker arm 20. Zero-turn lawnmowers as contemplated by this invention have rear-driven wheels 6, 7 that are independently controllable with left and right steering levers 4, 5 respectively. Thus, with forward wheel steering mechanism 10 implemented with zero-turn lawnmower 2, an operator can independently control each of the forward and rearward wheels.

It may further be appreciated that in some zero-turn lawnmower designs, only a single forward wheel may be implemented or multiple forward wheels may be implemented. Thus, it may be appreciated that a single foot pedal may be used to control one or more of the forward wheels.

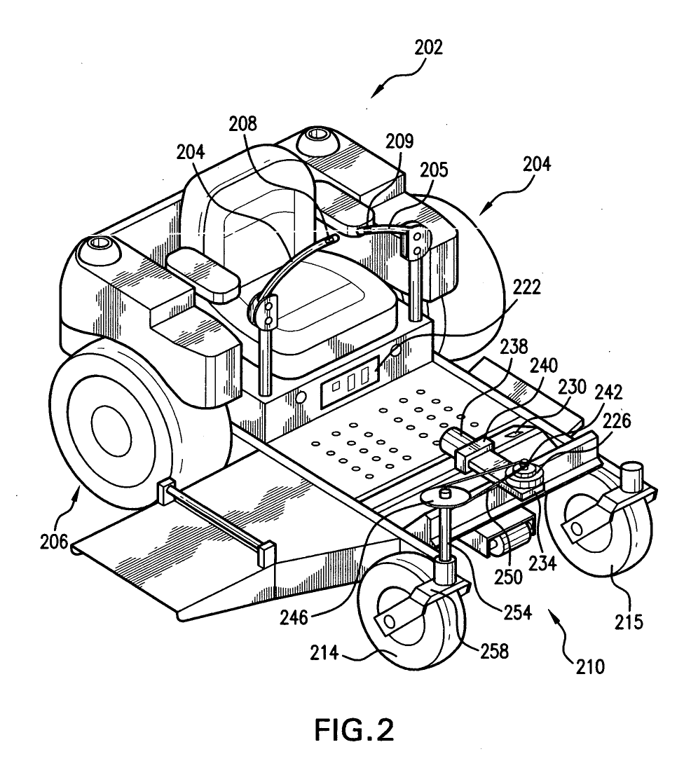

Referring to FIG. 2, zero-turn lawnmower 202 is shown representing an example of a second embodiment of the invention. Zero-turn lawnmower 202 includes right and left steering levers 204, 205 for respectively controlling the direction and rotational speed of right and left rear wheels 206, 207 and right and left turn hand actuated switches 208, 209 for respectively controlling the direction of right forward wheel 214 through forward wheel steering mechanism 210. Forward wheel steering mechanism 210 of the present invention is shown that is electro-mechanically implemented and usable by an operator of a zero-turn lawnmower to control the direction of orientation of right front wheel 214. In the displayed embodiment, forward wheel steering mechanism 210 includes right and left hand actuated switches 208, 209 attached to right and left steering levers 204, 205 and connected to circuit board 222 for driving a signal to cause right forward wheel 214 respectively to turn in the right or left direction. (It may be appreciated that right forward wheel 214 can be turned 360 degrees or multiple thereof, in either direction. Hand actuated switches 208, 209 may be mechanically or electrically designed to open or close a circuit on the circuit board.) Circuit board 222 is electrically connected to activate electric clutch 226 by engagement of clutch engage switch 230 with the foot of an operator.

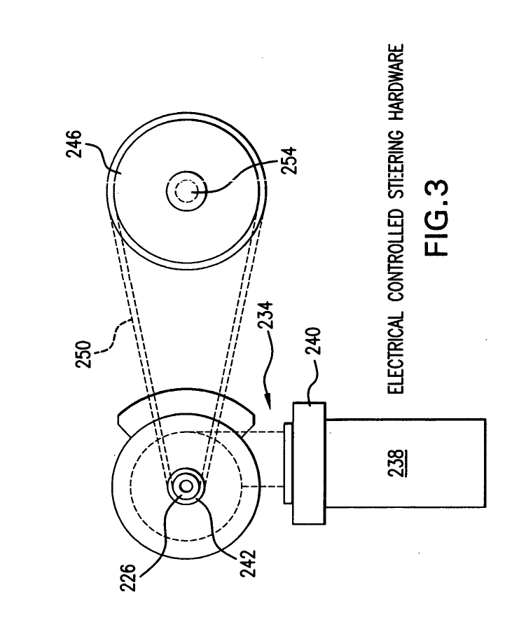

Continuing to refer to FIG. 2 and also referring to FIG. 3, electric clutch 226 is connected to wormgear assembly 234 which is driven by electric motor 238. Electric motor 238 is mounted to the chassis of zero turn lawnmower 202 through mounting bracket 240. Depending upon the user's control of hand actuated switches 208, 209, electrical signals are sent to drive motor 238 in the clockwise or counterclockwise direction which in turn causes wormgear assembly 234 to wind in one direction or another. Electric clutch 226 and wormgear assembly 234 are mounted together with small sprocket 242 to drive the rotation of sprocket 242 about an axle. Small sprocket 242 connects to large sprocket 246 through chain assembly 250. Large sprocket 246 is connected to spindle adapter 254 which in turn connects to wheel housing 258. Chain assembly 250 may be spun clockwise or counter-clockwise to cause either a right or left turn of wheel 214 with respect to the chassis of the zero-turn lawnmower.

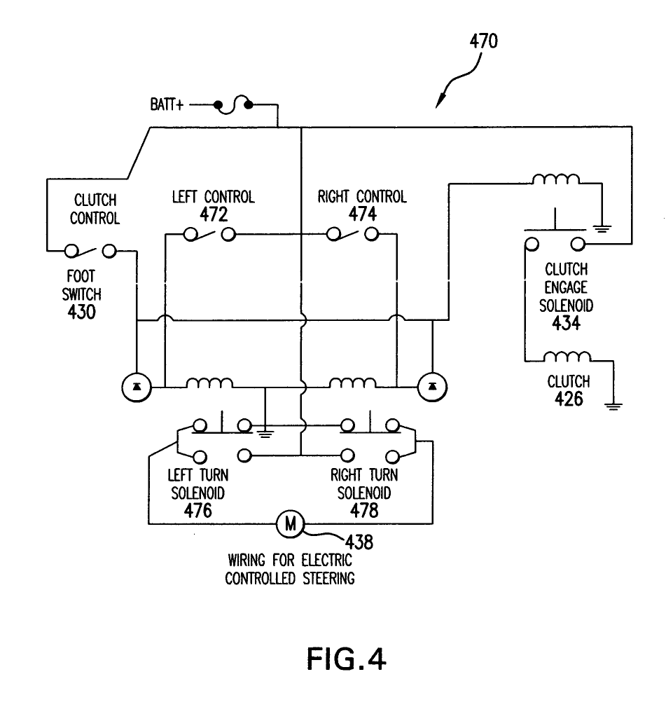

In one embodiment, hand actuated switches 208, 209 control electric signals that drives wheel 214 in the left and right directions, respectively. Referring to FIG. 4, example electrical circuit diagram 470 is shown with left and right electric control switches 472, 474 as actuated through hand actuated switches 208, 209 and electric clutch control switch 430 as actuated by foot controlled clutch engage switch 230. When clutch engage switch 240 is activated (such as by pressing with the foot of an operator), clutch control switch 430 completes an electric circuit that connects to clutch engage solenoid 434 which in turn activates clutch inductor 426 and causes electric clutch 226 to mechanically engage small sprocket 226 with wormgear assembly 234. When hand actuated switches 208, 209 are activated by an operator, left and right electric control switches 472, 474 respectively complete an electric circuit that connects to left and right turn solenoids 476, 478 to drive a signal through electric motor winding 438.

With respect to hand actuated switches 208, 209, it may be appreciated that instead of switches, alternate implementations could incorporate buttons, a pressure pad or joystick to control the direction of turn of wheel 14 and it may further be appreciated that the control of direction of wheel 214 could be implemented on one steering lever, such as steering lever 204. It may further be appreciated that forward steering mechanism 210 may be implemented on each forward wheel to provide independent control of each wheel, such that a switch or switches for turning the right front wheel 214 could be placed on right steering lever 204 and a switch or switches for turning the left front wheel 215 could be placed on left steering lever 205. Also, multiple forward wheels could easily be synchronously controlled by one forward steering mechanism 210; in such case, an adjustment mechanism can be implemented to increase the speed of the outside wheel or wheels with respect to the axis of rotation.

In a third embodiment of a zero turn lawnmower with a forward wheel steering mechanism (not shown), a fully or semi-automated forward wheel steering mechanism such as 210 (referring to FIG. 2-4) can be adapted and activated by an operator as by a hand or foot switch to activate a circuit board, such as a modified circuit board 470, which includes a digital signal processor (DSP) connecting to a set of sensors. The DSP is programmed to receive motion, speed, and pressure information; and based on its program and the received information, the DSP sends signals to activate clutch engage solenoid 434 and left turn or right turn solenoids 476, 478. By example, motion sensors can be implemented to detect whether the lawnmower is moving forward or backward and whether the lawnmower is on an incline (pitch and yaw). Sensors can be attached to the rear wheels to measure the revolutions per minute of each of the rear wheels. With this information, the DSP can algorithmically determine whether one or both rear wheels are spinning. Based on the information received and evaluated, the DSP sends a signal to turn the left and/or right front wheels in a direction according to its algorithm. Additional sensors can be implemented to measure hydraulic pressure related to the steering of the left and right rear wheels or braking, such that as the hydraulic pressure rises, the DSP can determine how hard an operator is attempting to drive the right or left rear wheel. Depending upon the information, the DSP can determine to turn the right or left front wheel to assist the operator's efforts.

The above description of illustrated embodiments of the invention is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

Various embodiments of the invention may utilize values that are different from what is specified herein. Additionally, the terms used in the following claims should not be construed to limit the invention to the specific embodiments disclosed in the specification and the claims.

What is claimed is:

1. A front wheel steering mechanism for a zero turn lawnmower with rear drive and steering, the front wheel steering mechanism including a steering assembly for controlling the direction of at least one forward wheel of the zero turn lawnmower.

2. The front wheel steering mechanism as in claim 1, the steering assembly comprising a mechanical control mechanism connecting to and controlling the direction of orientation of the at least one forward wheel.

3. The front wheel steering mechanism as in claim 1, the steering assembly comprising an electro-mechanical control mechanism connecting to and controlling the direction of orientation of the at least one forward wheel.

4. The front wheel steering mechanism as in claim 1, the steering assembly comprising an automated control mechanism connecting to and controlling the direction of orientation of the at least one forward wheel,
the automated control mechanism including a digital signal processor and at least one sensor, the at least one sensor for monitoring a motion characteristic and transmitting information to the digital signal processor, the digital signal processor for transmitting a control signal to adjust the direction of orientation of the at least one forward wheel.

5. The front wheel steering mechanism as in claim 2, the mechanical control mechanism including a foot pedal depressable by an operator of the zero turn lawnmower to cause a change in orientation of the at least one forward wheel with respect to the chassis of the zero turn lawnmower.

6. The front wheel steering mechanism as in claim 3, the electro-mechanical control mechanism including a hand portion with an actuator portion for sending an electrical signal and a mechanical portion for changing the orientation of the at least one forward wheel as a result of the electrical signal.

7. The front wheel steering mechanism as in claim 3, the electro-mechanical control mechanism including a clutch engageable by an operator, the clutch for engaging the electro-mechanical control mechanism with the at least one forward wheel.

8. The front wheel steering mechanism as in claim 6, the electro-mechanical control mechanism including an electric motor, the direction of rotation of the electric motor being controllable by the electrical signal of the hand portion, the direction of rotation of the electric motor for controlling the direction of orientation of the at least one forward wheel.

9. The front wheel steering mechanism as in claim 6, the mechanical portion including a gear and chain assembly for changing the direction of orientation of the at least one forward wheel,
the electro-mechanical mechanism including an electric motor for driving the gear and chain assembly according to the electrical signal.

10. The front wheel steering mechanism as in claim 9, the gear and chain assembly including a wormgear connecting to the shaft of the electric motor.

11. A zero turn lawnmower including a rear wheel driving mechanism and a front wheel steering mechanism, the front wheel steering mechanism including a steering assembly controlling the direction of orientation of at least one forward wheel of the zero turn lawnmower.

12. The zero turn lawnmower as in claim 11, the steering assembly comprising a mechanical control mechanism connecting to and controlling the direction of orientation of the at least one forward wheel.

13. The zero turn lawnmower as in claim 11, the steering assembly comprising an electro-mechanical control mechanism connecting to and controlling the direction of orientation of the at least one forward wheel.

14. The zero turn lawnmower as in claim 11, the steering assembly comprising an automated control mechanism connecting to and controlling the direction of orientation of the at least one forward wheel,
the automated control mechanism including a digital signal processor and at least one sensor, the at least one sensor monitoring a motion characteristic and transmitting information to the digital signal processor, the digital signal processor using the information to develop and transmit a control signal to adjust the direction of orientation of the at least one forward wheel.

15. The zero turn lawnmower as in claim 12, the mechanical control mechanism including a foot pedal depressable by an operator of the zero turn lawnmower to cause a change in orientation of the at least one forward wheel with respect to the chassis of the zero turn lawnmower.

16. The zero turn lawnmower as in claim 13, the electro-mechanical control mechanism including a hand portion sending an electrical signal and a mechanical portion changing the orientation of the at least one forward wheel in accordance with the electrical signal.

17. The zero turn lawnmower as in claim 13, the electro-mechanical control mechanism including a clutch engageable by an operator, the clutch engaging the electro-mechanical control mechanism with the at least one forward wheel.

18. The zero turn lawnmower as in claim 16, the electro-mechanical control mechanism including an electric motor, the direction of rotation of the electric motor being controllable by the electrical signal of the hand portion, the direction of rotation of the electric motor controlling the direction of orientation of the at least one forward wheel.

19. The zero turn lawnmower as in claim 16, the mechanical portion including a gear and chain assembly changing the direction of orientation of the at least one forward wheel,
the electro-mechanical mechanism including an electric motor driving the gear and chain assembly according to the electrical signal.

20. The zero turn lawnmower as in claim 19, the gear and chain assembly including a wormgear connecting to the shaft of the electric motor.
